(19) United States
(12) Patent Application Publication
(10) Pub. No.: US 2011/0084066 A1
(43) Pub. Date: Apr. 14, 2011

(54) SLIDABLE TRAY ASSEMBLY FOR MICROWAVE OVEN

(76) Inventors: Charles Gibson, Hackettstown, NJ (US); Dolleva Rogers, Brooklyn, NY (US)

(21) Appl. No.: 12/706,830

(22) Filed: Feb. 17, 2010

Related U.S. Application Data
(60) Provisional application No. 61/250,178, filed on Oct. 9, 2009.

(51) Int. Cl. H05B 6/64; B65D 1/34

(52) U.S. Cl. 219/762; 206/557

(57) ABSTRACT

According to at least one embodiment, a slidable tray assembly for a microwave oven is disclosed. The slidable tray assembly includes a horizontal portion having a size configured to fit within the interior cavity of a microwave oven, a vertical portion coupled to the horizontal portion, a recess defined in the top surface of the horizontal portion; and a pair of slide rails attached to the inner cavity of the microwave oven.

### RELATED APPLICATION

This patent application claims priority, under 35 U.S.C. §119(e), to U.S. provisional patent application No. 61/250,178, filed on Oct. 9, 2009, the disclosure of which is incorporated by reference herein in its entirety.

### BACKGROUND

Microwave ovens are widely utilized as a fast and convenient method of heating and cooking food and liquids. While a microwave oven may heat and cook food more rapidly than a conventional convection oven, the food may frequently cooked unevenly, leaving undesirable hot and cold spots in the food. Certain microwave ovens known in the art provide a rotatable turntable to facilitate evenly distributing heat throughout the food. Yet even when utilizing a turntable, hot and cold spots may remain in the food, and some foods may need frequent stirring to ensure that they are cooked evenly. However, the front-loading configuration and horizontal orientation of most microwave ovens does not allow the user enough space to conveniently and safely access the food while it is in the oven.

Moreover, withdrawing and replacing the food from the oven may be cumbersome and carry risk of burn or injury. Dishes placed in the microwave are frequently hot and require careful handling when the user desires to withdraw the dish from the oven. Additionally, handling dishes containing liquids carries with it the risk of spillage of hot liquid, which may be exacerbated by the weight of the dish and its contents.

### SUMMARY

According to at least one exemplary embodiment, a slidable tray assembly for a microwave oven is disclosed. The slidable tray assembly can include a horizontal portion having a size configured to fit within the interior cavity of a microwave oven, a vertical portion coupled to the horizontal portion, a recess defined in the top surface of the horizontal portion; and a pair of slide rails attached to the inner cavity of the microwave oven.

According to another exemplary embodiment, a sliding tray for a microwave oven can include a horizontal portion having a size configured to fit within the interior cavity of a microwave oven, an aperture defined in the horizontal portion; a vertical portion coupled to the horizontal portion, a recess defined in the top surface of the horizontal portion, a pair of slide rails attached to the inner cavity of the microwave oven, a rotatable turntable, the turntable further comprising a tray portion and a support portion, and a spline member, the spline member configured to pass through the aperture, to engage the support portion and to disengageably couple with a turntable driving mechanism of the microwave oven.

### BRIEF DESCRIPTION OF THE FIGURES

Advantages of embodiments of the present invention will be apparent from the following detailed description of the exemplary embodiments thereof, which description should be considered in conjunction with the accompanying drawings in which:

FIG. 1a is an exemplary diagram of a microwave oven having a slidable tray assembly.

FIG. 1b is an exemplary diagram of a microwave oven with the slidable tray assembly withdrawn.

FIG. 2a is an exemplary diagram of a microwave oven having a slidable tray assembly with a turntable.

FIG. 2b is an exemplary diagram of a microwave oven with the slidable tray assembly with a turntable withdrawn.

FIG. 2c is an exemplary diagram of a turntable for an exemplary embodiment of a slidable tray assembly.

### DETAILED DESCRIPTION

Aspects of the invention are disclosed in the following description and related drawings directed to specific embodiments of the invention. Alternate embodiments may be devised without departing from the spirit or the scope of the invention. Additionally, well-known elements of exemplary embodiments of the invention will not be described in detail or will be omitted so as not to obscure the relevant details of the invention. Further, to facilitate an understanding of the description, discussion of several terms used herein follows.

The word “exemplary” is used herein to mean “serving as an example, instance, or illustration.” Any embodiment described herein as “exemplary” is not necessarily to be construed as preferred or advantageous over other embodiments. Likewise, the terms “embodiments of the invention,” “embodiments” or “invention” do not require that all embodiments of the method, system or apparatus include the discussed feature, advantage or mode of operation.

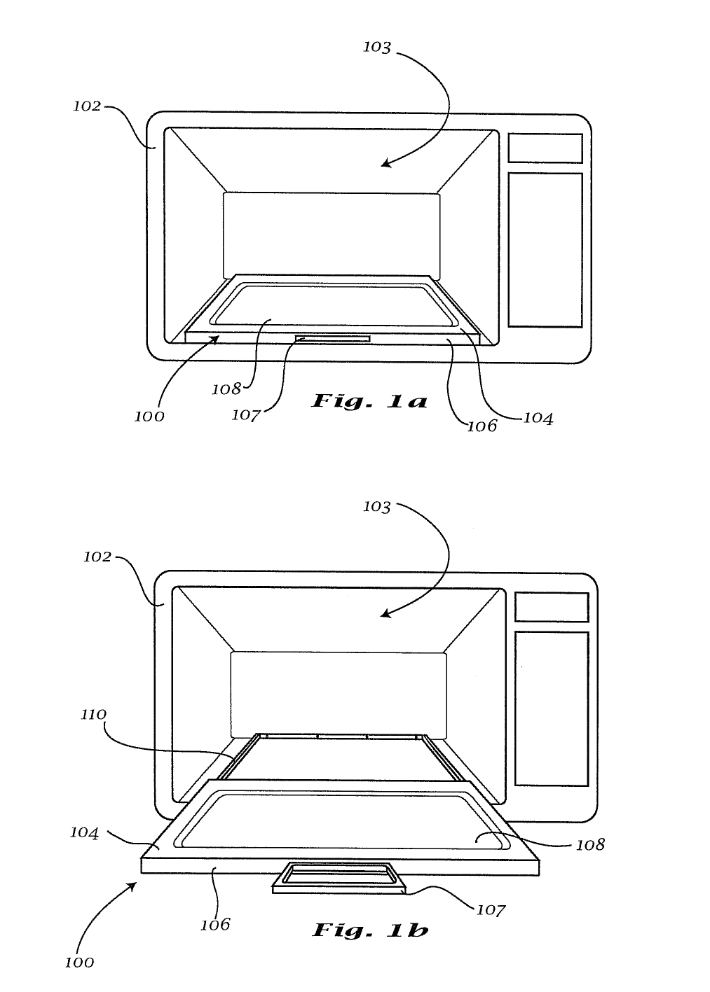

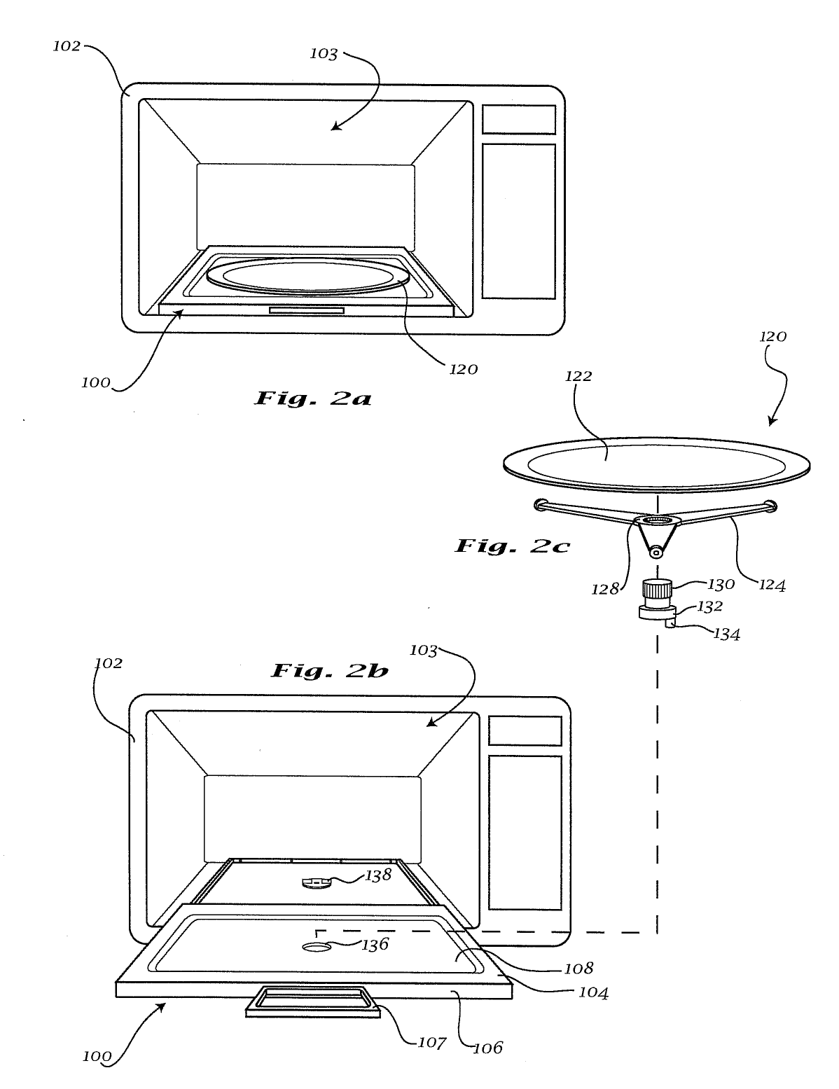

Generally referring to FIGS. 1-2, a slidable tray assembly for a microwave including an apparatus, method and system, is disclosed. The slidable tray assembly 100 may be of a size configured to fit within the interior cavity 103 of a microwave 102. In one embodiment, the slidable tray assembly may include a rotatable turntable 120.

Slidable tray assembly 100 may be substantially rectangular in shape and may include a horizontal portion 104 and a vertical portion 106. Horizontal portion 104 may have a length and a width such that slidable tray assembly may be received within the interior cavity 103 of a microwave 102. Horizontal portion 104 can also have a thickness that imparts slidable tray assembly 100 with structural rigidity that is substantially sufficient to inhibit flexing of slidable tray assembly 100. Horizontal portion 104 may facilitate supporting food items, while vertical portion 106 may aid the user in withdrawing assembly 100 from interior cavity 103 of microwave oven 102. Assembly 100 may be constructed of plastic, glass, heat-resistant glass, or any microwave-safe material known to one having ordinary skill in the art. Horizontal portion 104 may include a recess 108 defined in the top surface of horizontal portion 104. Recess 108 may facilitate maintaining food items within recess 108 during movement of assembly 100 in and out of interior cavity 103.

In one exemplary embodiment, vertical portion 106 of slidable tray assembly 100 may include a handle 107 to facilitate withdrawing assembly 100 from cavity 103. Handle 107 may be defined in the surface of and contiguous with vertical portion 106. In one exemplary embodiment, handle 107 may be movably mounted within a housing defined in the surface of vertical portion 106. In the exemplary embodiment, handle 107 may include a mechanism operating on a push-to-close and push-to-open principle, such that the user may depress handle 107 inward to withdraw handle 107 from the housing and may likewise depress handle 107 inward to replace and latch handle 107 within the housing.

Slidable tray assembly 100 may include a pair of slide rails 110 mounted on the sides of assembly 100. Slide rails 110 may be coupled to horizontal portion 104, vertical portion 106, or both. Slide rails 110 may facilitate withdrawing and replacing assembly 100 from cavity 103. Slide rails 110 may be fixedly mounted to the inner surfaces of cavity 103 of microwave oven 102. In one embodiment, slide rails may be removably mounted to the inner surfaces of cavity 103 by screws, adhesives, suction cups, or any other attachments known in the art. Slide rails 110 may be any type of linear slide apparatus known to one having ordinary skill in the art and manufactured from any microwave-safe material known to one having ordinary skill in the art. Slide rails 110 may also include ball bearings, a Teflon coating, or any friction-reducing means known to one having ordinary skill in the art.

In one exemplary embodiment, slidable tray assembly 100 may include a rotatable turntable 120. Rotatable turntable 120 may include a tray portion 122 and a support portion 124. Support portion 124 may include wheels or bearings 126 rotatably coupled to support portion 124 and movably engaged with horizontal portion 104 of slidable tray assembly 100. Support portion 124 may also include a center hub 128 configured to engage a spline member 130 of slidable tray assembly 100. Support portion 124 may thus facilitate supporting and rotating tray portion 122 around its center.

Spline member 130 may be rotatably coupled to slidable tray assembly 100 and may pass through an aperture 136 defined center of horizontal portion 104. Aperture 136 may be defined in a location of horizontal portion 104 such that when slidable tray assembly 100 is disposed fully within cavity 103, aperture 136 is located substantially above a turntable driving mechanism 138 of microwave oven 102. The upper end of spline member 130 may engage center hub 128 of turntable support portion 124 and the lower end of spline member 130 may engage turntable driving mechanism 138. The lower end of spline member 130 may also be configured to engage and disengage turntable-driving mechanism 138 of microwave oven 102 such that slidable tray assembly 100 may be easily withdrawn out of and replaced into cavity 103 of microwave oven 102. For example, lower end of spline member 130 may include a wheel 132 with at least one eccentric nub 134 that may be engaged by at least one tooth on turntable driving mechanism 138 of microwave oven 102.

The foregoing description and accompanying drawings illustrate the principles, preferred embodiments and modes of operation of the invention. However, the invention should not be construed as being limited to the particular embodiments discussed above. Additional variations of the embodiments discussed above will be appreciated by those skilled in the art.

Therefore, the above-described embodiments should be regarded as illustrative rather than restrictive. Accordingly, it should be appreciated that variations to those embodiments can be made by those skilled in the art without departing from the scope of the invention as defined by the following claims.

What is claimed is:

1. A slidable tray assembly for a microwave oven, comprising:
a horizontal portion having a size configured to fit within the interior cavity of a microwave oven;
a vertical portion coupled to said horizontal portion;
a recess defined in the top surface of said horizontal portion; and
a pair of slide rails attached to the inner cavity of the microwave oven.

2. The slidable tray assembly of claim 1, wherein said vertical portion further comprises a handle.

3. The slidable tray assembly of claim 2, wherein said handle is movable with respect to said vertical portion.

4. A sliding tray for a microwave oven, comprising:
a horizontal portion having a size configured to fit within the interior cavity of a microwave oven;
an aperture defined in said horizontal portion;
a vertical portion coupled to said horizontal portion;
a recess defined in the top surface of said horizontal portion;
a pair of slide rails attached to the inner cavity of the microwave oven;
a rotatable turntable, said turntable further comprising a tray portion and a support portion; and
a spline member, said spline member configured to pass through said aperture, to engage said support portion and to disengageably couple with a turntable driving mechanism of the microwave oven.

5. The slidable tray assembly of claim 4, wherein said vertical portion further comprises a handle.

6. The slidable tray assembly of claim 5, wherein said handle is movable with respect to said vertical portion.

7. The slidable tray assembly of claim 5, wherein said spline member further comprises a wheel comprising an eccentric nub.

8. The slidable tray assembly of claim 5, wherein said support portion of said rotatable turntable further comprises a center hub configured to engage said spline member.
